(19) United States
(12) Patent Application Publication
(10) Pub. No.: US 2006/0282902 A1
(43) Pub. Date: Dec. 14, 2006

(54) Security device and method for information processing apparatus

(76) Inventor: Hisashi Matsushita, Osaka (JP)

Correspondence Address: RATNERPRESTIA, P.O. BOX 980, VALLEY FORGE, PA, 19482, US

(21) Appl. No.: 11/287,782

(22) Filed: Nov. 28, 2005

(30) Foreign Application Priority Data
Jun. 10, 2005 (JP) 2005-170634

(51) Int. Cl. H04N 7/16

(52) U.S. Cl. 726/26

(57) ABSTRACT

Security data such as a password is stored as backup in flash memory in a PC, and even if someone removes a coin battery for CMOS backup from the PC, the removal is detected and the data backed up in the flash memory is reset in the CMOS. This feature strengthens the prevention of data theft from recording media such as HDDs due to unauthorized use or access of PCs.

### BACKGROUND OF THE INVENTION

1. Field of the Invention

The present invention relates to a security device and method for an information processing apparatus such as a personal computer.

2. Background Art

In recent years, portable information processing apparatus such as laptop personal computers (hereinafter, PCs) have been in widespread use. In return for the convenience of portability, however, a large number of theft cases of these devices as well as of information stored in them have been occurring, and this has become a social issue. In order to address this problem, as is well known, recent PCs are provided with a security function. For example, a PC can be protected from unauthorized use by not activating the OS (Operating System) unless a password is entered and verified, thereby preventing the PC from starting. An information processing apparatus with a structure of this kind is disclosed in Japanese Patent Unexamined Publication No. 10-105432.

When a user accesses individual information in a PC, it is common that the validity of the password is checked. However, it can be understood with a certain level of knowledge about PCs where in the PC the password consisting of a certain number of alphanumeric characters is stored. Therefore, there are probably a lot of people who know that a PC can be started without entering any password only by clearing the data in the region for storing a password, which will be described later. This fact indicates that the provision of a password-checking step cannot reduce the risk for this system to be broken, thereby making it impossible to effectively protect individual information from unauthorized access.

For security, most laptop PCs are designed not to start unless a correct password is entered. FIG. 3B shows an entry screen for a BIOS password, which is required for a program called BIOS (Basic Input/Output System). When a BIOS password (hereinafter, referred to simply as “password”) is set, it is impossible even to load data from the hard disk without entering this password, thereby indicating the strength of the security.

When setting a password, a BIOS setup menu is called up. FIG. 3A shows a BIOS password setting screen. The set content is stored in a CMOS region called the “south bridge” in the LSI, and maintained by a backup battery after the power is off, so that the password data is never erased. Therefore, with this password set on the BIOS, it is difficult to start the PC without entering this password.

However, this conventional structure is not sufficient for the security of PCs because of the following reasons.

If a backup battery mounted on the PC motherboard is temporarily removed, and the electric charge remaining on the motherboard is discharged by short-circuiting the printed board pattern, then the password and other security function settings stored in the CMOS are all cleared. The removed backup battery can be put back onto the motherboard to restore at least the factory default BIOS settings. Since the set password has been cleared, the PC can be started without entering any password. In this manner, data stored in the HDD (Hard Disk Drive) in a PC may be taken without authorization.

### SUMMARY OF THE INVENTION

The present invention provides a security device for an information processing apparatus, the security device comprising: a first recording medium which is installed in the information processing apparatus and which stores legitimate security data entered at a time of starting the information processing apparatus; a second recording medium which is installed in the information processing apparatus and which stores the legitimate security data; and a detection means for detecting that the legitimate security data stored in the first recording medium has been one of being erased and damaged, wherein when the detection means has detected that the legitimate security data stored in the first recording medium has been one of being erased and damaged, the legitimate security data stored in the second recording medium is stored in the first recording medium.

The present invention also provides a security method for an information processing apparatus provided with a plurality of recording media, the security method comprising: detecting that legitimate security data stored in a first recording medium has been one of being erased and damaged; and upon detection that the legitimate security data stored in the first recording medium has been one of being erased and damaged, storing the legitimate security data stored in a second recording medium in the first recording medium.

According to the present invention, security data such as a password is stored as backup in flash memory in a PC, and even if someone removes a coin battery for CMOS backup from the PC, the removal is detected and the backup information about the security data such as the password stored in the flash memory is reset in the CMOS. This feature strengthens the prevention of data theft from recording media such as HDDs due to unauthorized use or access of PCs.

### BRIEF DESCRIPTION OF THE DRAWINGS

FIG. 1 is a view to show a general PC hardware structure according to a first embodiment of the present invention.

FIG. 2 is a flowchart depicting a security method for an information processing apparatus according to the first embodiment of the present invention.

FIG. 3A is a view to show a BIOS password setting screen.

FIG. 3B is a BIOS password entry screen.

### DETAILED DESCRIPTION OF PREFERRED EMBODIMENT

An embodiment of the present invention will be described as follows with reference to accompanying drawing. It should be noted that the present invention is not limited to the embodiment.

### Embodiment

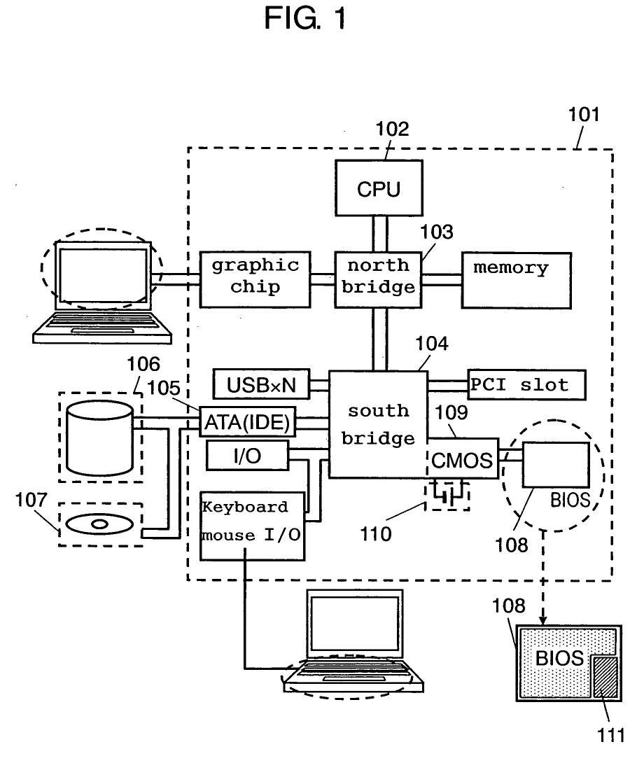

In FIG. 1, motherboard 101 is a part on which to fix or mount main components of a PC. North bridge 103 and south bridge 104 constitute what is commonly called a chip set. North bridge 103 controls data flow between CPU (Central Processing Unit) 102, memory and a graphic chip. South bridge 104 controls data flow between ATA (IDE) interface 105 connecting HDD 106 and CD/DVD drive 107, the interface of a keyboard and mouse, expansion cards (PCI slots such as a LAN card or sound card) and other interfaces. Nonvolatile flash memory 108 contains a program which is called the BIOS to control peripherals such as HDD 106, CD/DVD 107 and FDD (Floppy Disk Drive unillustrated) connected to the PC. The set content of the BIOS can be modified by the user pushing a predetermined button to call up a setup menu immediately after the starting of the PC. The set content is stored in CMOS 109 which is in the CMOS region of south bridge 104, and maintained even after the power is turned off because it is backed up by coil battery 110.

Flash memory 108 is a nonvolatile semiconductor memory which can read data as well as erase and rewrite data in a predetermined sequence, and can also maintain data even after the power is turned off.

The following is a description about the operation of a security device for the PC thus structured. The password is stored in CMOS 109 and maintained even after the PC is shut down because coin battery 110 backs up CMOS 109. However, if someone removes the coin battery 110 temporarily from motherboard 101 and short-circuits the printed circuit pattern, then the password stored in CMOS 109 is erased because the function to back up CMOS 109 is lost. This problem is avoided by the following procedure.

(1) The BIOS is programmed in such a manner that when the user calls up the setup menu to set a password, backup region 111 is separately secured in flash memory 108 where the BIOS itself is stored, and data which is important in terms of security such as a password is stored in backup region 111.

(2) The BIOS is programmed in such a manner that if someone removes coin battery 110 for CMOS-data backup from the PC, the CMOS data is checked at the starting of the PC so as to detect the removal of coin battery 110 by checksum or other method. A checksum, which is an error detection scheme, is obtained by dividing data into blocks and taking the sum of numerical values of the data in these blocks. The calculated checksum is stored with the data. When the stored data is read out, a checksum is also calculated from the data stream to check whether it coincides with the checksum read out. If they are different, then that means the read data has an error, indicating that the coin battery 110 has been removed from the PC. It goes without saying that not only the removal of the battery from the PC, but also drain and deterioration of the battery are detected as well.

(3) The BIOS is programmed in such a manner that when the removal of coin battery 110 is detected by the checking of the CMOS data by the checksum, the password data separately stored in backup region 111 of flash memory 108 is reset in CMOS 109 so as to restore the data.

(4) The BIOS is programmed in such a manner that data which is important in terms of security besides a password is read from backup region 111 of flash memory 108, and the damaged or erased security data is reset in CMOS 109 so as to restore the data.

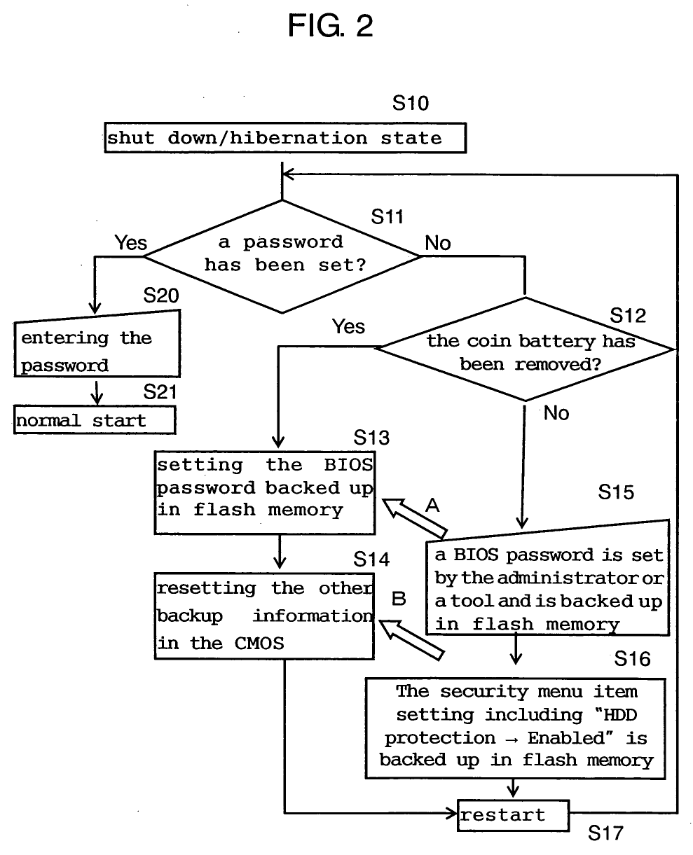

The following is a description about a security method for an information processing apparatus of the present invention with reference to FIG. 2.

The BIOS is programmed to proceed as follows. When the PC is started from a shutdown/hibernation state (S10), it is determined whether a password has been set or not (S11). When a password has been set, the user is prompted to enter the password (S20). The password is checked for validity and when the password is determined to be valid, the PC starts normally so as to start the OS (S21).

On the other hand, when it is determined that no password has been set (S11), it is determined whether the coin battery has been removed or not from the checking results of CMOS 109 (S12).

When it is determined that the coin battery has been removed from the PC (S12), the password backed up in flash memory 108 is reset in CMOS 109 (S13). The other backup information is also reset in CMOS 109 (S14) to restart the PC (S17). Since the password has been restored at this point in time, entering the password (S20) can make the PC start normally (S21).

In contrast, when it is determined that the coin battery has not been removed (S12), the PC is determined to be in the factory default state and the user is allowed to set the CMOS at Step (S15). The CMOS setting is done by the user with the BIOS setup utility so as to efficiently perform the collective setting of CMOS data when he/she begins to use the PC. In the setting, as shown by the arrow of FIG. 2, flash memory 108 backs up the CMOS data which have been set collectively at the password setting (S15) and the security menu item setting (S16). After the security menu item setting at Step (S16) and the CMOS setting are over, the user restarts the PC (S17) to use it.

The security menu item setting (S16) includes an HDD protection function. This is a function to prevent the data stored in the HDD from being read out when the HDD alone is removed and attached to another PC. The user can choose the setting between enabled and disenabled in the security menu.

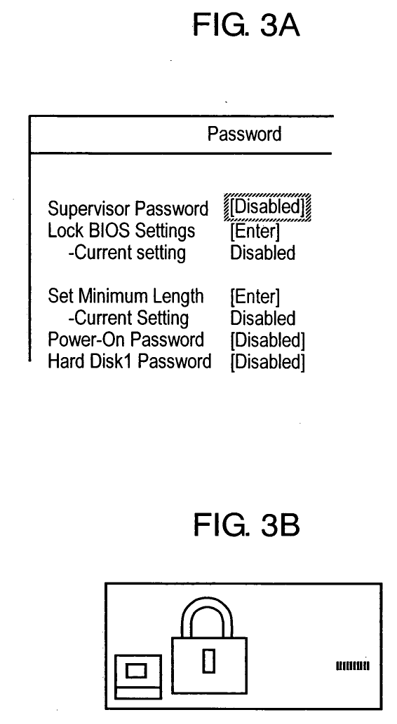

For example, as shown in the bottom line of FIG. 3A, when Hard Disk1 Password is made Enabled, the password entry unit is displayed on the next line. Then, setting and entering a HDD password in the password entry unit makes it impossible to read the data stored in the HDD with an invalid password when the HDD is attached to another PC.

The BIOS also has a retry number setting function to set the number of password faults allowed. When an invalid password is entered over this number, the PC is forcibly powered off. The BIOS also has a data erase function for self protection to erase programs or data in the HDD when an invalid password is entered more than the number of password faults allowed. The setting between enabled and disabled of the data erasing function and the retry number setting function are included in the security menu item setting (S16).

As described hereinbefore, the security device and method for an information processing apparatus of the present invention have the following features.

Security data such as a password is stored as backup in flash memory in a PC, and even if someone removes a coin battery for CMOS backup from the PC, the removal is detected and the backup information about the password and other security data stored in the flash memory is reset in the CMOS. This feature strengthens the prevention of data theft from recording media such as HDDs due to unauthorized use or access of PCs.

Therefore, the security device and method for an information processing apparatus of the present invention can be used for various information processing apparatus including PCs.

What is claimed is:

1. A security device for an information processing apparatus, the security device comprising:
a first recording medium which is installed in the information processing apparatus and which stores legitimate security data entered at a time of starting the information processing apparatus;
a second recording medium which is installed in the information processing apparatus and which stores the legitimate security data; and
a detection means for detecting that the legitimate security data stored in the first recording medium has been one of being erased and damaged, wherein
when the detection means has detected that the legitimate security data stored in the first recording medium has been one of being erased and damaged, the legitimate security data stored in the second recording medium is stored in the first recording medium.

2. A security method for an information processing apparatus provided with a plurality of recording media, the security method comprising:
detecting that legitimate security data stored in a first recording medium has been one of being erased and damaged; and
upon detection that the legitimate security data stored in the first recording medium has been one of being erased and damaged, storing the legitimate security data stored in a second recording medium in the first recording medium.
